(19) United States
(12) Patent Application Publication
(10) Pub. No.: US 2002/0086688 A1
(43) Pub. Date: Jul. 4, 2002

(54) Method for processing messages in a cellular base station system

(75) Inventor: Sung-Min Kang, Songnam-shi (KR)

Correspondence Address: Paul J. Farrell, DILWORTH & BARRESE, LLP, 333 Earle Ovington Blvd., Uniondale, NY, 11553, US

(73) Assignee: Samsung Electronics Co., Ltd.

(21) Appl. No.: 09/848,065

(22) Filed: May 3, 2001

(30) Foreign Application Priority Data
Dec. 29, 2000 (KR) 86140/2000

(51) Int. Cl. H04M 11/10

(52) U.S. Cl. 455/466; 455/412; 455/445

(57) ABSTRACT

Disclosed is a method for processing messages in a cellular base station system including a plurality of subsystems. At least one field is added to a message format exchanged between the subsystems in a software update process used by the subsystems. A source subsystem generates a message header including an interface version field having source current running version value, generates a message by assembling the generated message header and at least one information field, and transmits the generated message to a target subsystem. The target subsystem then compares the source current running version value in the received message header with a target current running version value; processes the received message including the added field, if the source current running version value is equivalent to the target current running version value; and processes the received message excluding the added field, if the source current running version value is not equivalent to the target current running version value.

### PRIORITY

This application claims priority to an application entitled “Method for Processing Messages in a Cellular Base Station System” filed in the Korean Industrial Property Office on Dec. 29, 2000 and assigned Serial No. 2000-86140, the contents of which are hereby incorporated by reference.

### BACKGROUND OF THE INVENTION

1. Field of the Invention

The present invention relates generally to a cellular mobile communication system, and in particular, to a method for processing messages exchanged between subsystems constituting a base station system (BSS).

2. Description of the Related Art

A cellular mobile communication system divides its entire service area into a plurality of base station areas, called a “cell”, and controls the base stations using mobile switching centers (MSCs) on a centralized basis, so that a mobile subscriber can maintain a call even while moving from one cell to another cell.

FIG. 1 illustrates a structure of a common cellular base station system (BSS). Referring to FIG. 1, base transceiver subsystems (BTSs) 10-14 connect radio channels to mobile stations (not shown) in the associated cell, and base station controllers (BSCs) 20-22 control their associated BTSs 10-14. A base station manager (BSM) 30 controls the entire base station system.

In such a base station system, in order to exchange messages in a predetermined format with one another, the respective subsystems must operate with a proper version of a software program, which can support the message format. Thus, if the software is updated (or upgraded) to a new version, every subsystem must download the updated version of the software and install the downloaded software.

A conventional software update procedure will now be described in detail with reference to FIG. 1. The base station manager 30 disables every software block (i.e., every block for providing the mobile communication service), which uses the current running version N-1 of the software, and then, installs a new version N of the software. The base station controllers 20-22 sequentially download the new version N of the software from the base station manager 30 and install the downloaded new version N of the software in the same process. Likewise, the base transceiver subsystems 10-14 also download the new version N of the software from their associated base station controllers 20-22 and install the downloaded new version N of the software. As described above, the base station manager, the base station controllers, and the base transceiver subsystems suspend (or interrupt) an operation for the mobile communication service prior to updating the software. This is because a software block using the current running version cannot process a message received from a software block using the updated version.

FIG. 2 illustrates a method for processing messages in the base station system according to the prior art. Referring to FIG. 2, when a subsystem in the base station system receives a message from another subsystem in step S110, the subsystem analyzes the received message using the current running version of the software in step S120, to determine whether the received message has a normal format, which can be processed by the current running version of the software. If the received message has a normal format, the subsystem normally processes the received message in step S130. Otherwise, if the received message has an abnormal format, the subsystem treats the received message as an error message and discards the received message in step S140.

FIGS. 3A and 3B illustrate message formats modified in the conventional software update procedure. As illustrated, a message format of the updated version N additionally includes a new field ‘eee’, as compared with the message format of the previous version N-1. Since a subsystem operating with the previous version N-1 of the software cannot recognize the new field ‘eee’, the subsystem treats the message as an error message. Actually, in most cases, the software is slightly updated such that the modified message format additionally includes one or more new fields. In this case, the subsystem using the previous version of the software unconditionally treats the message as an error message, even though it can recognize the other fields except the newly added fields.

Therefore, the subsystems using the different versions of the software cannot communicate with each other, so that the mobile communication service must be suspended until the software update procedure is completed. In addition, if one of the subsystems fails to update the software during the software update procedure, it is necessary to restore the already-updated new version installed in the other subsystems to the previous version, thus causing an increase in the service suspension (or interruption) time.

### SUMMARY OF THE INVENTION

It is, therefore, an object of the present invention to provide a method for enabling subsystems using different versions of a software program to be able to communicate with each other.

It is another object of the present invention to provide a method for enabling a subsystem to be able to detect a software version of another subsystem, using a message having a field indicating a software version.

To achieve the above and other objects, there is provided a method for processing messages in a cellular base station system including a plurality of subsystems. At least one field is added to a message format exchanged between the subsystems in an update process of a software program used by the subsystems. A source subsystem generates a message header including an interface version field having a source current running version value, generates a message by assembling the generated message header and at least one information field, and transmits the generated message to a target subsystem. The target subsystem then compares an interface version field value in the received message header with a target current running version value; processes the received message including the added field, if the source current running version value is equivalent to the target current running version value; and processes the received message excluding the added field, if the source current running version value is not equivalent to the target current running version value.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram illustrating a structure of a common cellular base station system;

FIG. 2 is a flow chart illustrating a conventional method for processing messages in a base station system;

FIGS. 3A and 3B are diagrams illustrating message formats modified by a conventional software update procedure;

FIG. 4 is a flow chart illustrating a procedure for transmitting messages according to an embodiment of the present invention;

FIGS. 5A and 5B are diagrams illustrating message formats modified according to an embodiment of the present invention; and

FIG. 6 is a flow chart illustrating a procedure for receiving messages according to an embodiment of the present invention.

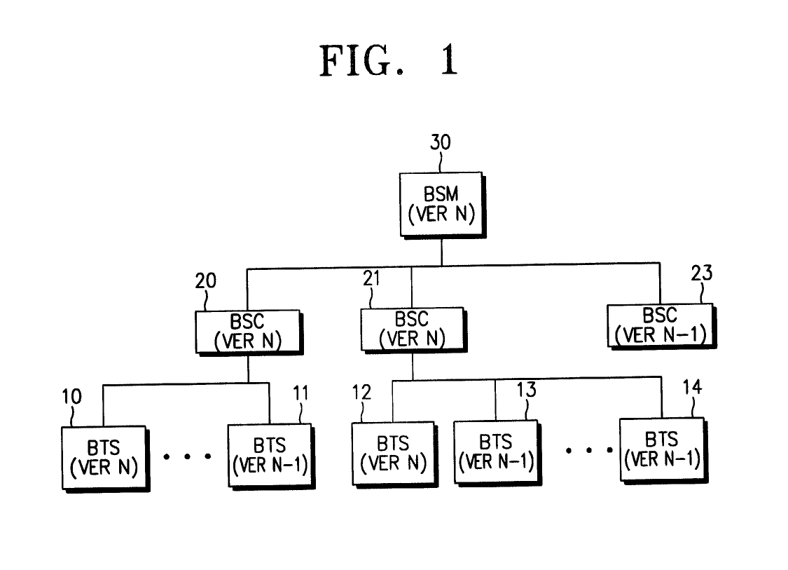

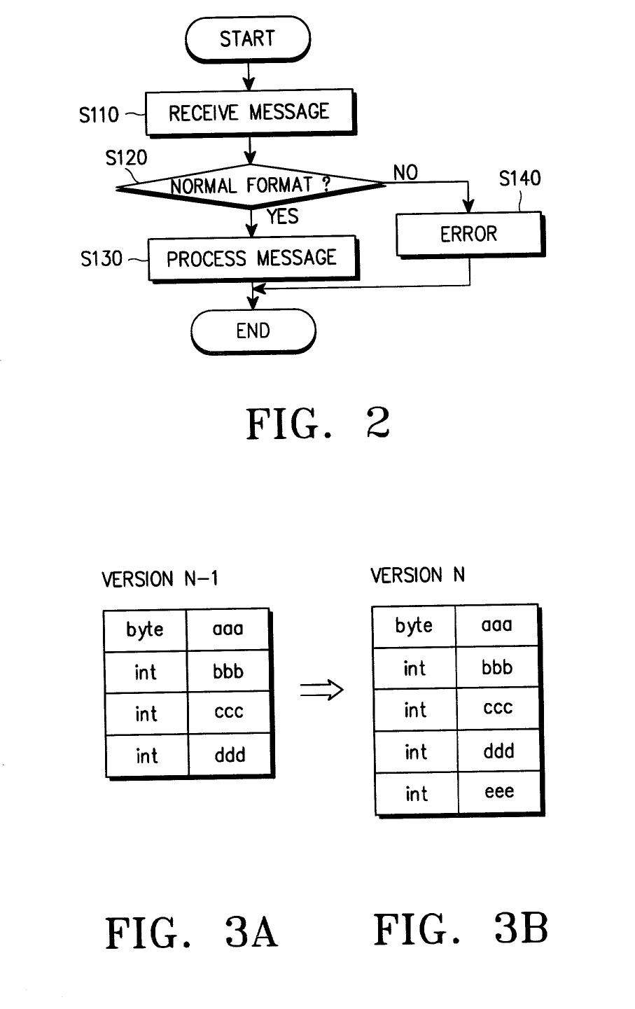

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

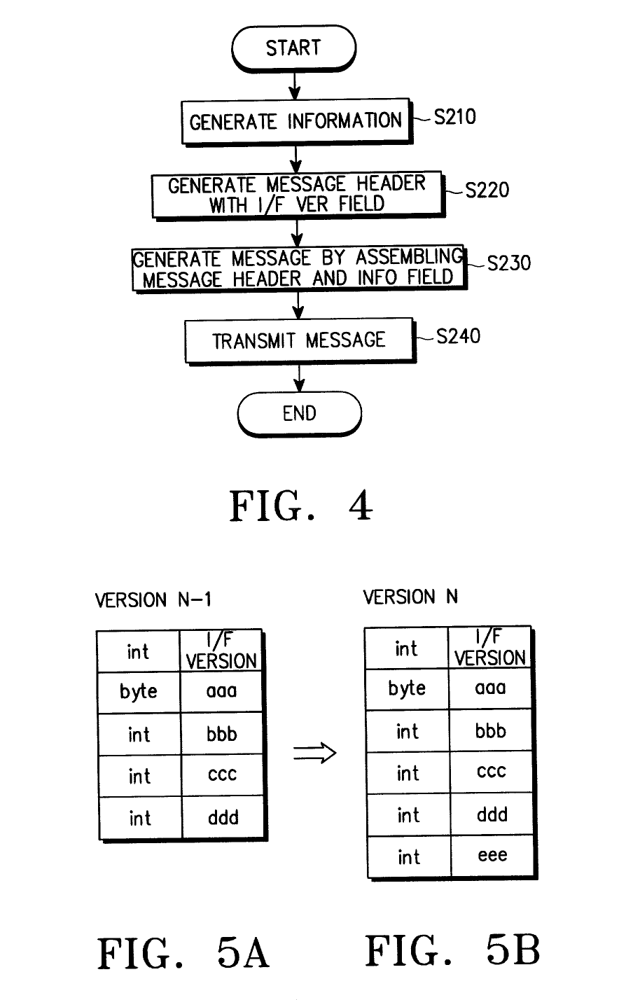

FIG. 4 illustrates a procedure for transmitting messages according to an embodiment of the present invention.

Referring to FIG. 4, if there is information to transmit in step S210, a source subsystem creates a message header including an interface version field (I/F_VER) having a source current running version (SCRV) value of the software in step S220. If the current running version of the software is a version N, the SCRV value is set to ‘N’. In step S230, the source subsystem generates a message by assembling the created message header and at least one information field. In step S240, the source subsystem transmits the generated message to a target subsystem via a communication link.

The subsystem downloads the interface version field from its upper subsystem when downloading the software. This interface version field is used to determine whether the software is already updated or not, in the software update process. In the embodiment of the present invention, the message exchanged between the subsystems includes the SCRV value of the source subsystem.

FIGS. 5A and 5B illustrate the message formats modified according to an embodiment of the present invention. As illustrated, each header of the non-updated message (version N-1) and the updated message (version N) includes an interface version field (I/F_VER) indicating the SCRV value used by the source subsystem. The subsystems in the base station system have a transmission/reception buffer, the size of which is set to a prescribed maximum size, i.e., a size sufficient to receive the added field, for the communication between the subsystems. This is to store the message having the added field in the buffer without loss.

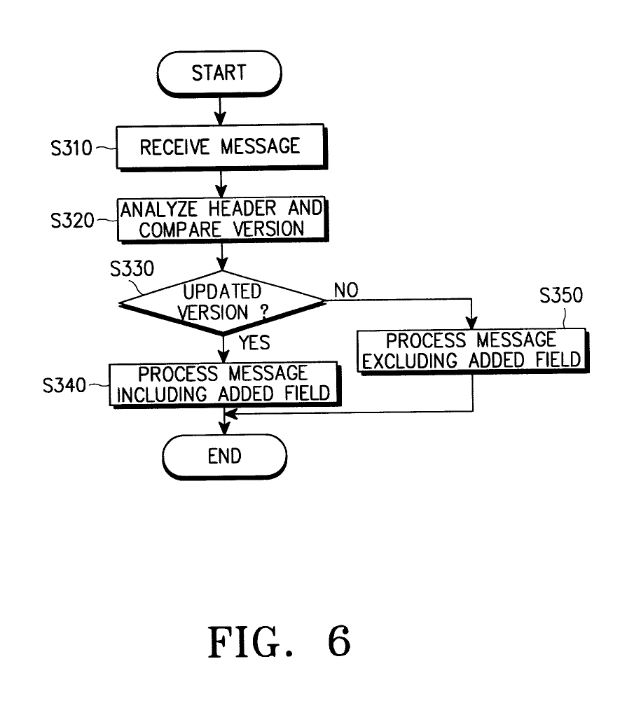

FIG. 6 illustrates a procedure for receiving messages according to an embodiment of the present invention.

Referring to FIG. 6, when the target subsystem receives a message from the source subsystem in the base station system in step S310, the target subsystem analyzes the received message using the current running version of the software in step S320, and compares, in step S320, the SCRV value in the message header with its software version value to determine in step S330 whether the software version used by the source subsystem is an updated version. The target subsystem determines that the software version of the source subsystem is an updated version, if the SCRV value is larger than or equal to a target current running version (TCRV) value, the version of the software running at the target subsystem.

If the SCRV value is determined to be equivalent to the TCRV value, the target subsystem processes the received message including the field added by the software update process in step S340. That is, the target subsystem processes all of the fields ‘aaa’, ‘bbb’, ‘ccc’, ‘ddd’ and ‘eee’ of the received message. Otherwise, if the SCRV value is determined not to be equivalent to the TCRV value, the target subsystem processes the received message excluding the added field in step S350. That is, the target subsystem recognizes only the fields ‘aaa’, ‘bbb’, ‘ccc’ and ‘ddd’ of the received message as valid fields, and processes those fields only. The procedure for processing the message fields according to a protocol (or software) predetermined between the subsystems is well known in the art. Therefore, the detailed description of the procedure will not be provided herein.

Now, an operation of the present invention will be described with reference to specific examples.

Among a plurality of the subsystems constituting the base station system, some subsystems are assumed to use a version 1 of the software, while the other subsystems are assumed to use a version 2 of the software downloaded in the software update procedure.

As one example, a source subsystem using the version 1 of the software sets the interface version field in the header of the transmission message to the SCRV value ‘1’ (i.e., I/F_VER=1). Upon receipt of the message transmitted from the source subsystem, if a target subsystem using the version 2 of the software detects the SCRV value ‘1’ from the message header, the target subsystem processes only the fields version 1 of the software can analyze (i.e., the fields ‘aaa’ to ‘ddd’ of FIG. 5A). In this case, the target subsystem does not treat the received message as an error message, even though the received message does not have the field ‘eee’ added in the version 2.

As another example, a source subsystem using the updated version 2 of the software sets the interface version field in the transmission message header to its SCRV value ‘2’ (i.e., I/F_VER=2). Upon receipt of the message transmitted from the source subsystem, if a target subsystem using the version 1 of the software detects the SCRV value ‘2’ from the message header, the target subsystem processes only the fields version 1 of the software can analyze (i.e., the fields ‘aaa’ to ‘ddd’ of FIG. 5B). In this case, the target subsystem discards the added field ‘eee’ included in the received message.

That is, the subsystem using the previous version of the software considers only the message format declared (or defined) by the previous version of the software, and the subsystem using the updated version of software can consider both the message format of the previous version and the message format of the updated version.

As one application of the present invention, when the base station manager for controlling the software update process of the entire base station system updates the software, the base station manager may store the previous version of the software for backup without deleting it. Then, when the lower subsystems restart and download the software, they may download a selected one of the previous version and the updated version of the software and install the downloaded version.

The message processing method according to the present invention has the following advantages. As described above, the novel method guarantees compatibility between the different versions of software. Thus, the base station system including a plurality of subsystems can minimize a service suspension time caused by the software update process. Therefore, it is possible to increase working efficiency of the operator and reliability of the system.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A method for processing messages in a cellular base station system including a plurality of subsystems, comprising the steps of:
generating, in a source subsystem, a message header including an interface version field having a source current running software version value;
generating, in the source subsystem, a message by assembling the generated message header and at least one information field; and
transmitting the generated message from the source subsystem to a target subsystem.

2. A method for processing messages in a cellular base station system including a plurality of subsystems, comprising the steps of:
adding at least one field to a message format exchanged between the plurality of subsystems in a software update process used by the plurality of subsystems;
receiving, in a target subsystem, a message containing at least a message header from a source subsystem;
comparing, in the target subsystem, a source current running version value contained in the received message header with a target current running version of the target subsystem;
processing, in the target subsystem, the received message including the added field, if the source current running version value is equivalent to the target current running version value; and
processing, in the target subsystem, the received message excluding the added field, if the source current running version value is not equivalent to the target current running version value.

3. The method as claimed in claim 2, wherein the target subsystem includes a transmission/reception buffer, a size of which is set to a value capable of accepting the received message including the added field.

4. A method for processing messages in a cellular base station system including a plurality of subsystems, comprising the steps of:
adding at least one field to a message format exchanged between the plurality of subsystems in a software update process used by the plurality of subsystems;
generating, in a source subsystem, a message header including an interface version field having a source current running version value;
generating, in the source subsystem, a message by assembling the generated message header and at least one information field;
transmitting the generated message from the source subsystem to a target subsystem;
comparing, in the target subsystem, the source current running version value in the received message header with a target current running version value of the target subsystem;
processing, in the target subsystem, the received message including the added field, if the source current running version value is equivalent to the target current running version value; and
processing, in the target subsystem, the received message excluding the added field, if the source current running version value is not equivalent to the target current running version value.

5. A method for processing messages in a cellular base station subsystem including a plurality of subsystems, comprising the steps of:
adding at least one field to a message format exchanged between the plurality of subsystems in an update process of software used by the plurality of subsystems;
installing, in a base station manager for controlling the base station system, an updated version of the software and then backing-up a previous version of the software; and
downloading a selected one of the updated version and the previous version of the software from the base station manager and installing the downloaded software, when at least one of the plurality of subsystems restarts.

6. The method as claimed in claim 5, further comprising the steps of:
transmitting, in a source subsystem, a message having a message header including an interface version field having a source current running version value to a target subsystem;
detecting, in the target subsystem, the source current running version value from the received message header;
processing in the target subsystem, the received message using the updated version of the software, if the source current running version value is equivalent to a target current running version value of the target subsystem; and
processing, in the target subsystem, the received message using the previous version of the software, if the source current running version value is not equivalent to the target current running version value of the target subsystem.
